(19) United States
(12) Patent Application Publication
(10) Pub. No.: US 2010/0006703 A1
(43) Pub. Date: Jan. 14, 2010

(54) SYSTEM FOR RELEASING OPPOSING TENSIONED LINES

(75) Inventors: Corwin Hardham, Cooks, WA (US); Johannes Van Niekerk, Sunnyvale, CA (US); Daniel W. Meyers, Portland, OR (US); Gregory C. Ashton, Sammamish, WA (US)

Correspondence Address: GANZ LAW, P.C., P O BOX 2200, HILLSBORO, OR, 97123, US

(73) Assignee: HO SPORTS COMPANY, INC., Redmond, WA (US)

(21) Appl. No.: 12/375,214

(22) PCT Filed: Jul. 30, 2007
(86) PCT No.: PCT/US07/74778

§ 371 Date: Jan. 26, 2009

Related U.S. Application Data
(60) Provisional application No. 60/820,776, filed on Jul. 28, 2006.
(60) Provisional application No. 60/863,309, filed on Oct. 27, 2006.

(51) Int. Cl. B64C 31/06; B63B 35/85; F16G 11/00; F16G 11/10; B25G 3/00; B23P 11/00

(52) U.S. Cl. 244/153 R; 441/69; 244/155 A; 403/41; 29/428

(57) ABSTRACT

Release systems for tensioned lines, which release under a predetermined change in tension; particularly systems for use in towing airfoils for sports and recreational activities coupling the airfoil to a rider.

### CROSS REFERENCE TO RELATED APPLICATIONS

Under 35 U.S.C. §119, this application claims the benefit of and priority to U.S. provisional patent application No. 60/820,776, filed Jul. 28, 2006, by Corwin Hardham, et al, entitled AUTO-STABILIZED AIRFOIL; RELEASE SYSTEM FOR COUPLING OPPOSING TENSIONED LINES, and U.S. provisional patent application No. 60/863,309, filed Oct. 27, 2006 by Corwin Hardham, et al. entitled A TOWABLE AIRFOIL SYSTEM AND COMPONENTS AND ACCESSORIES THEREFOR the contents of which are hereby incorporated by reference as if included in their entirety for all purposes.

### BACKGROUND

In certain respects, the inventive subject matter disclosed herein relates to airfoils used to provide lift or tension on a tow line, particularly for use in recreational sports. In other respects the inventive subject matter relates to a coupling system for one or more tensioned lines suitable for use with a towed airfoil, for example, as a handle and safety release system. The inventive subject matter particularly relates to airfoils and line systems in water sports, such as wakeboarding and kiteboarding. Although not limited to such applications, they will be used to illustrate the inventive subject matter.

Towable water sports devices are used in various recreational and professional activities. These devices include water skis, kneeboards, wakeboards, water ski boards, tubes and other devices which are towed behind a motor boat or other towing vessel along with a rider. Typically, the rider stands, kneels, or sits on the device, and a tow line is held by the rider or attached to the device.

Wakeboarding, for example, is a recreational and professional sport that is rapidly increasing in popularity. In wakeboarding and other water sports, it is often desirable to jump off the water surface to add excitement to the activity, perform tricks or other aerial maneuvers, etc. Often, the wake created by the towing vessel is used as a ramp to facilitate jumping off the surface of the water. However, regardless of the amount of wake present, riders will often want to maximize the ability to jump off the water surface.

Accordingly, motor boats have been provided with elevated anchor points typically called wake towers to accommodate a higher angle of attachment of the rider tow line. Typically, a pylon, tower or like structure extends several feet above the deck of the boat (e.g., approximately 8-10 feet). This slightly increases the angle formed by the rider tow line with the surface of the water. The resulting upwardly directed force component allows the rider to jump higher off the water surface.

Various constraints limit the advantages obtained through use of such elevated anchor points. Typically, there are practical and other limitations on the height of elevated anchor point structures, for example hauling or fold-away limitations. Large towers can flex significantly, requiring stabilizing guy wires or other structural reinforcements within the boat. Towers can also adversely affect the stability of the towing vessel, due to leveraged forces exerted by the rider tow line on the tower, particularly when the rider pulls from one side of the motor boat. For these and other reasons, the jumping advantage provided by an elevated anchor point within a boat is limited.

To overcome the foregoing disadvantages a towable airfoil lift system was created and disclosed in U.S. Pat. No. 6,834,607, granted Dec. 28, 2004, entitled TOWING SYSTEM AND METHOD FOR A WATER SPORTS APPARATUS the contents of which are hereby incorporated by reference as if recited in full herein for all purposes. (At the time of the inventions disclosed herein, the '607 patent was owned by a common assignee.) While the lift system disclosed in that patent has provided a planform for a new sport, there is a continuing need for more stable and efficient airfoils and for improved line systems for coupling the airfoils to riders and tow vehicles.

### SUMMARY

The inventive subject matter herein overcomes the problems inherent in wakeboarding and conventional kite systems by providing novel lift devices, systems, and methods, which may be used in sports, as well as other applications. The following kite configuration factors, alone or in combination, may make the inventive airfoil more suitable for use in certain recreational activities. These include:
General aspect ratio from about 1:1 to about 2:1.
Towlines and kites lines that are releasably coupled with boat rider and kite, which stay coupled until a predetermined change in tension.
structural ribs in the kite body, using, for example, inflatable bladders
buoyant tips at the ends of the wing span The buoyant tips may be, for example, inflated tips, which allow the airfoil to float and taxi behind the boat without submerging, in the case of water-launched airfoils.
The tips may be inflated or otherwise provided so as to have a predetermined angle, to define the angle of attack of the inventive airfoil when the inventive airfoil is sitting on the water. This controls the speed at which the inventive airfoil will lift off of the water. This may help prevent premature launches.
Squat profile with wide wingtip separation. This helps keep the inventive airfoil stable on the water in the presence of cross-breezes.
Ability to have the airfoil ride stable in the air, providing lift.
Use of planing elements, such as air bladders or other buoyant front and bottom leading edges for water floatation, and easy lift off when pulled behind the boat.
Parabolic shaped top surface for venturi effect, adding lift.
Steering controls.
Simple tear-down and set up design based on inflatable bladders.
Sized according to lift aspect of less than 1 G, for example, from about ½ to ¾ G of a normal size person.

The inventive subject matter contemplates line coupling systems that releasable couple lines according to predetermined changes in tension (force). In a basic form, the release system includes a coupling apparatus that releasably connects opposing tensioned lines that are coupled via the apparatus. The coupling apparatus is adapted to release at least one of the tensioned lines when a neutral or stabilizing force is removed or overcome by the predetermined forces on one of the tensioned lines.

In certain possible embodiments, the inventive subject matter is directed to the following:

A lift system for sport or recreation, the system comprising an airfoil having the following configuration factors: an aspect ratio of from about 1:1 to about 2:1; planing elements on opposite sides of the airfoil span to facilitate planing of the airfoil on a surface, so as to maintain the airfoil in an upright position in take-off; a convex profile wherein the leading edge to length ratio is from about 3:1 to about 2:1; a profile with a maximum depth of from about 5% to about 15% of the chord length, or more suitably for some embodiments, 8%-12%; and sizing to provide a controlled lift to a person or a person and associated sport or recreational equipment.

A lift system, the system comprising an airfoil having the following configuration factors: an aspect ratio of from about 1:1 to about 2:1; sizing to provide a controlled lift to a person or a person and associated sport or recreational equipment; and buoyant planing elements on opposite sides of the airfoil span to facilitate planing of the airfoil on a water surface, so as to maintain the airfoil in an upright position in take-off.

In the foregoing embodiment, the airfoil may be configured with the following additional configuration factors: a leading edge that is longer than the trailing edge; a convex profile wherein the leading edge to length ratio is from about 3:1 to about 2:1; a profile with a maximum depth of from about 8% to about 12% of the chord length; structural elements generally between the leading edge and trailing edge; inflatable bladders comprising planing elements; an angle of attack from the center of the airfoil through to the tips of the airfoil; tips on opposite sides of the span of the airfoil, the rear portions of the tips being angled inwardly relative to the front portions to provide an angle of attack; rear tip portions are relatively more flexible than the front portions; the planing elements comprise the tips; the tips comprise tapered inflatable bladders; one or more drag elements comprising projecting surfaces generally disposed behind a tow point of the airfoil; one or more drag elements each comprising a surface projecting from the top surface of the airfoil and which are disposed behind a tow point of the airfoil; two or more drag elements comprising inflatable bladders disposed at about the trailing edge of the airfoil; a pair of opposing bridle lines, the bridles comprising an elastic section and an inelastic section; and/or bridle lines wherein a forward section is inelastic and a rear section is elastic.

In another possible embodiment, the inventive subject matter is directed to a method of making a lift system for sport or recreation, the method comprising: providing one or more panels of flexible material; and assembling or fabricating the panel or panels to have following configuration factors: an aspect ratio of from about 1:1 to about 2:1; a convex profile wherein the leading edge to length ratio is from about 3:1 to about 2:1; a profile with a maximum depth of from about 5% to about 15% of the chord length; sizing to provide a controlled lift to a person or a person and associated sport or recreational equipment; and assembling to or fabricating with the panels, planing elements on opposite sides of the airfoil span to facilitate planing of the airfoil on a surface, so as to maintain the airfoil in an upright position in take-off.

In another possible embodiment, the inventive subject matter is directed a method of making a lift system for sport or recreation, the method comprising: providing one or more panels of flexible material; and assembling or fabricating the panel or panels to have following configuration factors: an aspect ratio of from about 1:1 to about 2:1; sizing to provide a controlled lift to a person or a person and associated sport or recreational equipment; and assembling or fabricating to the panels buoyant planing elements on opposite sides of the airfoil span to facilitate planing of the airfoil on a water surface, so as to maintain the airfoil in an upright position in take-off.

In another possible embodiment, the inventive subject matter is directed to a method of providing lift to a towed rider, comprising: coupling an airfoil to a vehicle, the airfoil an airfoil having the following configuration factors: an aspect ratio of from about 1:1 to about 2:1; planing elements on opposite sides of the airfoil span to facilitate planing of the airfoil on a surface, so as to maintain the airfoil in an upright position in take-off; a convex profile wherein the leading edge to length ratio is from about 3:1 to about 2:1; a profile with a maximum depth of from about 5% to about 15% of chord length; and sizing to provide a controlled lift to a person or a person and associated sport or recreational equipment; coupling the airfoil to a person; and accelerating the vehicle to a speed that causes the airfoil to launch.

In another possible embodiment, the inventive subject matter is directed to a method of providing lift to a towed rider, comprising: coupling an airfoil to a vehicle, the airfoil an airfoil having the following configuration factors: an aspect ratio of from about 1:1 to about 2:1; buoyant planing elements on opposite sides of the airfoil span to facilitate planing of the airfoil on a water surface, so as to maintain the airfoil in an upright position in take-off, and sizing to provide a controlled lift to a person or a person and associated sport or recreational equipment; coupling the airfoil to a person; and accelerating the vehicle to a speed that causes the airfoil to launch.

In the foregoing methods of use, the vehicle may be a boat, and wherein a handle system is provided for coupling the rider to a boat and for coupling the rider to the airfoil, the handle receiving or being configured to receive a pair corresponding lines to the airfoil and a towline; the handle system may be associated with one or more release system for releasing an associated line on predetermined change in tension.

In still other embodiments, the inventive subject matter is directed to a release system, comprising: a coupling apparatus comprising a receiver and release element that is received by the receiver, each of which is connectable to an opposing line and holding the lines in coupled tension under a stabilizing force acting in a first plane; and wherein the coupling apparatus is adapted to release at least one of the tensioned lines when the stabilizing force is removed or overcome by a predetermined force in a transverse plane to the first plane.

In the foregoing embodiments the release system may be configured as follows: the receiver includes a recessed area for receiving the receiving element, the recessed area including a surface against which the receiving element abuts under a tension of the opposing lines, and recessed area has an open side through which the receiving element disengages under the transverse force; the opposing lines and the abutment surface all lie in substantially the first plane and the open side is facing transverse from the first plane; the system further comprises a handle for use by a rider being towed by a vehicle, the handle having at least one of the opposing lines coupled to the coupling apparatus and the release element is coupled to the other opposing line; the handle further includes at least a second line that is connected to the handle in a manner offset from the first line coupled to the handle such that rotation of the handle differentially changes the lengths of the lines, causing the receiver to rotate, releasing the release element; the handle further includes a line for coupling to an airfoil that is offset from a line coupling the handle to the coupling apparatus; a handle wherein when the stabilizing force is removed, its orientation, under tension from an airfoil line, will cause the receiver to rotate and release the release element; a tow line coupled to the release element; the line coupled to the release element comprises a tow line for a rider to be towed by a boat, the handle further including lines or coupling for coupling to an airfoil; a handle system comprising an elongate bar for a rider to grip while being towed, the handle being configured to couple with a tow line, and the handle additionally being configured to couple with one or more airfoil lines, the coupling point of the one or more airfoil lines being a point for vertical lift when a coupled airfoil is in flight; and/or a coupling apparatus for coupling the handle to a tow line, the coupling apparatus being releasable from the tow line upon a predetermined change in tension to the apparatus.

In other possible embodiments, the inventive subject matter is directed to a handle system for coupling lines in an airfoil towing system comprising a coupling apparatus for coupling a pair of lines, the coupling apparatus being releasable from a line upon a predetermined change in tension to the apparatus.

In the foregoing embodiments, the handle system may be configured as follows: a handle for a towed rider coupled to the coupling apparatus, and wherein the coupling apparatus is disposed between the handle and lines for or coupling to an airfoil; a handle for a towed rider coupled to the coupling apparatus, and a tow line for a rider, and wherein a first coupling apparatus is disposed between the handle and a towline, and a second coupling apparatus is disposed between a handle and a line for an airfoil; the handle comprises an elongate element that includes at least two connection points that are offset by virtue off having different radii from a central axis of the bar; and/or an airfoil having an aspect ratio of from about 1:1 to about 2:1 coupled to the handle system, and planing elements on opposite sides of the airfoil span to facilitate planing of the airfoil on a surface, so as to maintain the airfoil in an upright position in take-off.

In another possible embodiment, the inventive subject matter is directed to a coupling apparatus for releasably coupling a tensioned line, the apparatus comprising: a beam having a longitudinal axis and an eccentricity disposed therefrom at a deflectable end; a second end anchored to a housing portion, a release catch coupled to the deflectable end of the beam and in combination with a housing portion defining an area for releasably capturing a closed end line or loop, wherein the eccentricity is adapted to be an anchor for a tensioned line or structure such that a predetermined amount of tension causes deflection of the beam and couplingly opens the release catch to release a line in the area defined by the release catch and housing portion.

The foregoing embodiment may be configured as follows: in the coupling apparatus the relationship between the deformation of the deflectable portion of the beam and the force on the beam is non-linear.

Other possible embodiments are directed to making and using any of the foregoing coupling apparatuses, for example: a method of making a coupling apparatus comprises: providing a receiver and a release element that is received by the receiver, fashioning the receiver so that it is connectable to one of an opposing line and fashioning the release element so that it is connectable to a second opposing line, the receiver and release element being able to hold the lines in coupled tension under a stabilizing force acting in a first plane; and wherein the coupling apparatus is adapted to release at least one of the tensioned lines when the stabilizing force is removed or overcome by a predetermined force in a transverse plane to the first plane. In another example, a method of using a line system in a lift system, comprises: providing a handle that is configured to couple to a towline and an airfoil, the line system including a first releasable coupling disposed between the handle and towline or the handle and airfoil, the release system being reliable on a predetermined change in tension in a line coupled to the release system; providing an airfoil couplable to the handle coupling the line system to an airfoil and vehicle; and towing a rider holding the handle.

### BRIEF DESCRIPTION OF THE DRAWINGS

The following figures show various embodiments of inventive subject matter (except where prior art is noted).

FIG. 1A shows some basic elements of one possible embodiment of a lift system in a pre-launch set-up.

FIG. 1B shows the system of FIG. 1A after launching.

FIG. 2A-2D show basic dimensions of a kite, with FIG. 2A a plan view of the projected span of a kite, FIG. 2B a front view, FIG. 2C a side elevational view, FIG. 2D a plan view of the kite's flat wingspan.

FIGS. 3A and 4A show a conventional, prior art kiteboarding kite (FIG. 3A) as compared to an embodiment of the inventive airfoil (FIG. 4A).

FIGS. 3B and 4B show planform comparisons of the kites of FIGS. 3A and 4A.

FIGS. 3C and 4D show side elevational comparisons of the kites of FIGS. 3A and 4A.

FIGS. 3D and 4D show front view comparisons of the kites of FIGS. 3A and 4A.

FIG. 4E shows a rear view of the kite of FIG. 4A.

FIG. 4F shows an underside view of the kite of FIG. 4A.

FIG. 4G shows a top view of the kite of FIG. 4A.

FIGS. 5-8 are screen shots of an interface for kite design software, with parameters and data representing dimensions and profile data for an airfoil according to the inventive subject matter.

FIG. 9A shows a line coupling system the handle and coupling apparatus in the closed (neutral) position.

FIG. 9B shows the line coupling system of FIG. 9A in the open (released) position.

FIG. 10A show a possible embodiment of an inventive line coupling system for use in a line system for a towed lift device.

FIG. 10B shows a more detailed view of an inventive coupling apparatus for use in the line system of FIG. 10A.

FIG. 10C shows rotated view of the inventive coupling apparatus of FIG. 10B.

FIG. 11A shows a perspective side view of one possible embodiment of a coupling apparatus that provides release of tension lines upon a predetermined change in tension.

FIG. 11B shows a perspective side view of the coupling apparatus of FIG. 11A in a loaded state.

FIG. 11C illustrates a side sectional view of the coupling apparatus of FIG. 11A in a loaded state.

FIG. 11D illustrates a side sectional view of the coupling apparatus of FIG. 11A in a released state.

FIG. 12 is a graph showing non-linear deformation of the coupling apparatus of FIGS. 11A-D.

FIG. 13A shows another possible embodiment of an inventive line coupling system for use in a line system for a towed lift device, which is a variation of the coupling system of FIGS. 10A-C.

FIG. 13B shows a rotated view of the embodiment of FIG. 13A.

FIG. 13C shows a rotated view of the embodiment of FIG. 13B.

FIG. 13D shows a rotated view of the embodiment of FIG. 13C.

FIG. 14 shows another possible embodiment of an inventive handle and coupling system, which is a variation of the coupling system of FIG. 9A.

### DETAILED DESCRIPTION

### Auto-Stabilized Airfoil

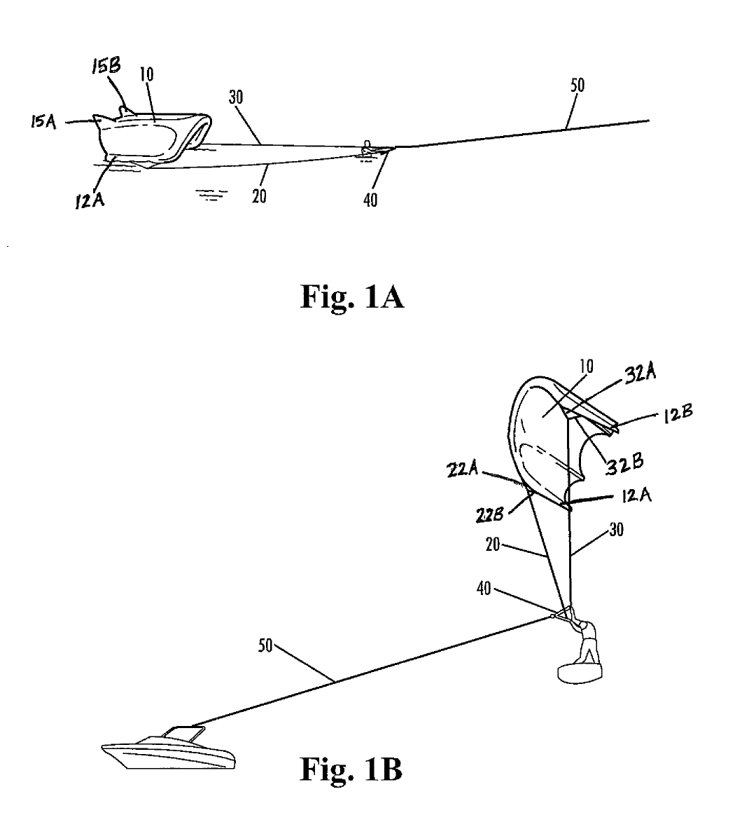

In certain respects the inventive subject matter herein is directed to an auto-stable airfoil, namely a shaped body that when moved through a fluid produces a force perpendicular to the direction of motion of an airfoil, such as a kite, and which is auto-stable in flight. As used herein, an auto-stable airfoil means an airfoil that tends to fly at a zenith, centered overhead, position and tends to recover, without rider input, from non-constant forces that cause yaw or roll perturbations during intended conditions of use. For recreational water sports, such as wakeboarding and water skiing, tow speeds typically range from about 18 mph to about 30 mph. An auto-stable airfoil may also be coupled with steering controls, such as conventional steering lines coupled to a kite's bridle lines. FIG. 1 illustrates basic components of a towable airfoil system. The system includes an airfoil 10, control lines 20 and 30 coupled to the kite and a rider via a handle 40, for example, and a towline 50 coupled to a boat or other tow vehicle and the rider via handle 40, for example.

An airfoil may be not only a kite, but also could be a wing or blade, for example. The airfoil is particularly useful in providing lift to an object coupled to the airfoil via a tensioned line. The airfoil is more particularly useful for towing behind a vehicle including an automobile or boat. For purposes of illustrating the inventive auto-stabilizing airfoil, a lift system for assisting a wakeboarder is described below. The airfoil, and portions thereof, may be based on inflatable, buoyant, or other forms that are configured to provide lift, drag and/or buoyancy. The following description will be in terms of an airfoil in the nature of a kite. However, this is an illustrative example, and the inventive subject matter may be readily adapted for use with other forms of airfoils.

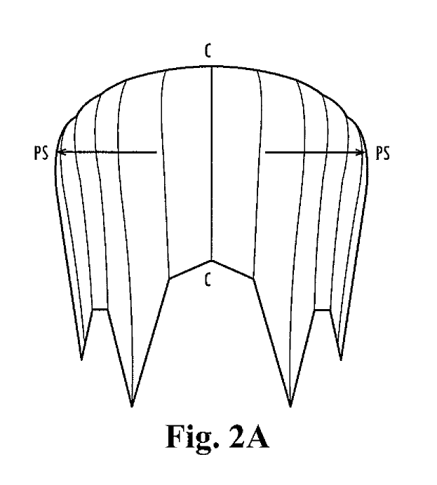

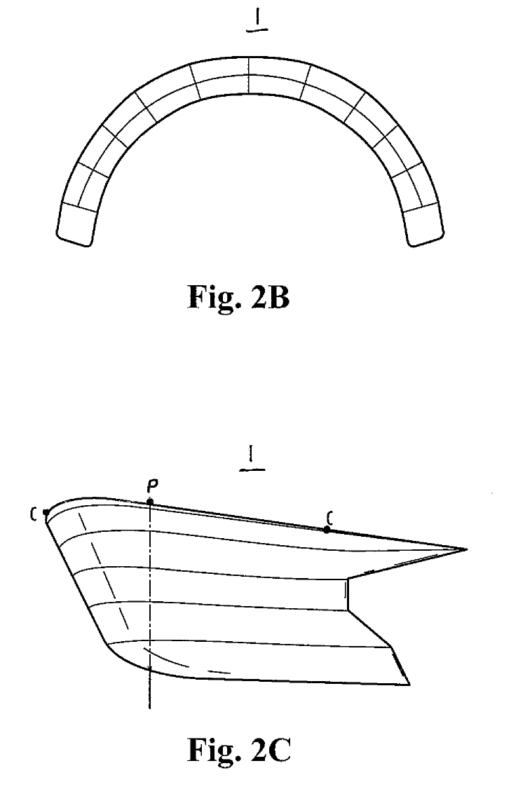

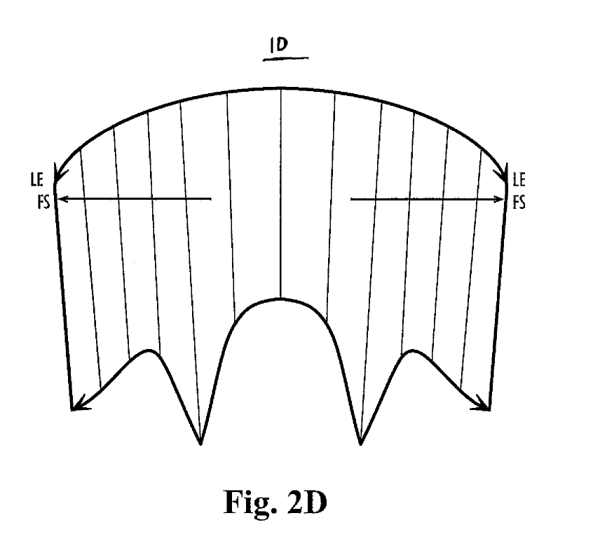

FIG. 2A-2D show basic features and dimensions of a kite 1. FIG. 2A is a plan view of the projected span of a kite according to the inventive subject matter. In general, a kite has a leading edge indicated by line LE-LE and a trailing edge generally indicated by line TE-TE. The line PS-PS shows the projected span of the kite. The kite has a chord, indicated by line C-C running down the center of the span, from the leading edge to the trailing edge. The span and chord are the dimensions used in calculating the aspect ratio of a kite, as discussed in more detail below. FIG. 2B a front view of the kite. FIG. 2C is a side elevational view of the kite, and a profile alignment point P is a point that is a point on the chord C-C that is a predetermined percentage of the chord length, measuring from the leading edge side of the chord, and which corresponds to the kite's center of pressure “CoP”. Normally, the kite's tow point is positioned a small distance behind the CoP. FIG. 2D is a plan view of the kite's flat wingspan.

In certain embodiments, the inventive airfoil design differs from conventional kites in that it is designed to be auto-stable. The auto-stability of the inventive airfoil is facilitated by one or more of the following kite configuration factors: (1) an aspect ratio of from about 1:1 to about 2:1; (2) drag elements, such as angled projections 15A and 15B, at opposite sides of the trailing edge to provide drag, especially at low angles of attack; (3) a convex profile wherein the leading edge to chord length ratio is from about 3:1 to about 2:1; a leading edge that is longer than the trailing edge to provide an angle of attack across any cross section taken along the kite's chord; and a profile with a maximum depth of from about 5% to about 15% of the chord length. In some embodiments, a preferable depth may be about 8% to about 12%.

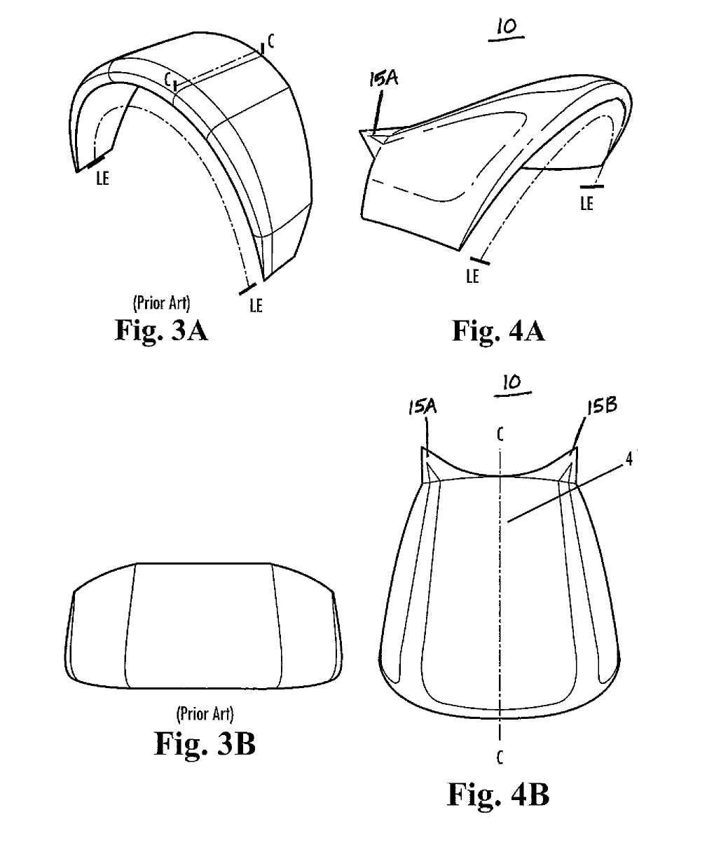

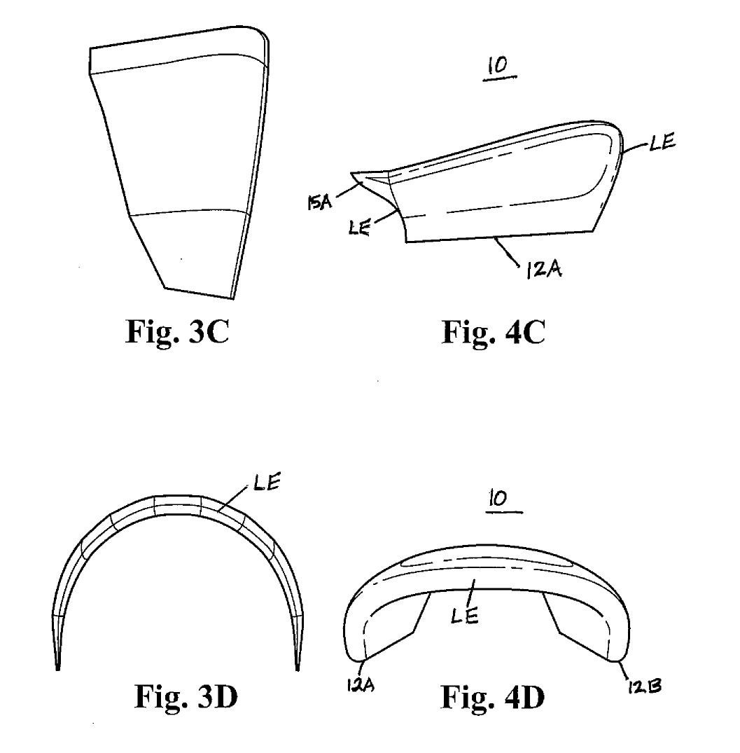

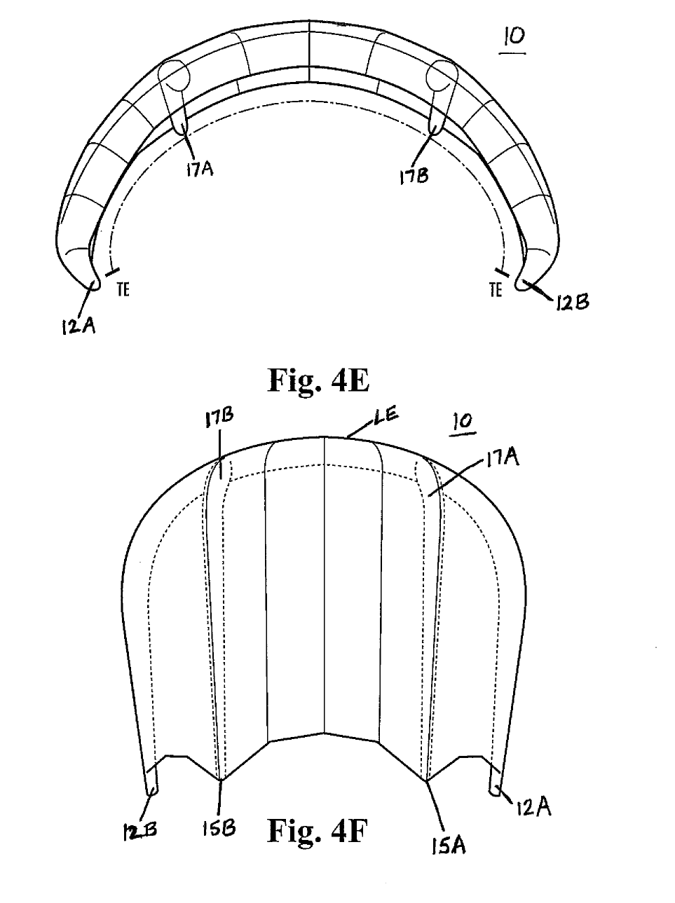

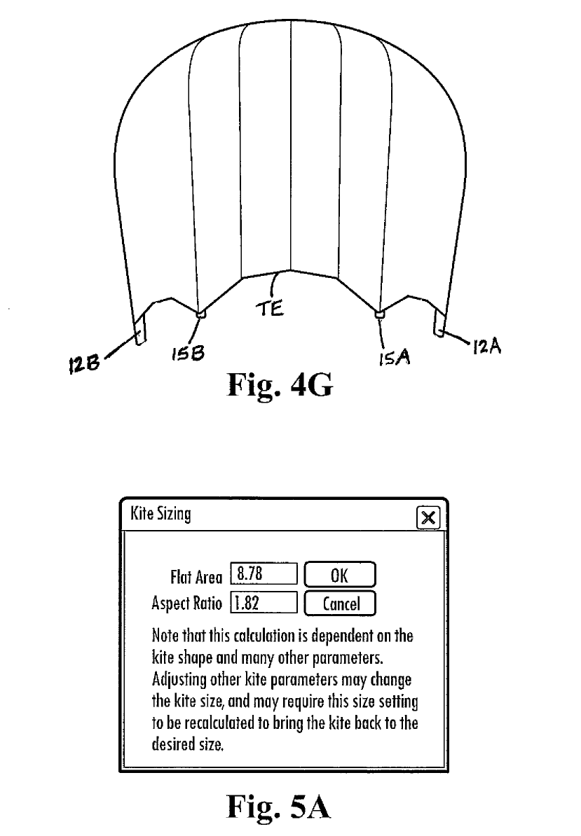

Using the foregoing kite configuration factors, the inventive airfoils' configurations differ substantially from conventional airfoils used in sports such as kiteboarding (FIG. 4). An exemplary inventive kite implementing the foregoing configuration factors is shown and contrasted with a conventional kiteboarding kite in FIGS. 3-4. FIGS. 3A and 4A show a conventional, prior art kiteboarding kite (FIG. 3A) as compared to an embodiment of the inventive airfoil (FIG. 4A). FIGS. 3B and 4B show planform comparisons of the kites of FIGS. 3A and 4A. FIGS. 3C and 4D show side elevational comparisons of the kites of FIGS. 3A and 4A. FIGS. 3D and 4D show front view comparisons of the kites of FIGS. 3A and 4A. FIG. 4E shows a rear view of the kite of FIG. 4A. FIG. 4F shows an underside view of the kite of FIG. 4A. FIG. 4G shows a top view of the kite of FIG. 4A. FIG. 3A show a conventional, prior art kiteboarding kite as compared to an embodiment of the inventive airfoil.

Looking more particularly at the aspect ratio (“AR”) configuration factor, the AR is approximately the span/chord of the kite, or more precisely the span×span/area. In kiteboarding, power is important because the kites are not towed but count entirely on the wind to generate thrust. Accordingly such kites need to accelerate faster to produce needed power. As a general rule, power is achieved by providing a kite profile with relatively high ARs, typically of about 5 or more. In determining the AR of a kite, the chord is generally measured at the center of the span of the kite. The area is the flat area of the kite, which is the total surface area of the kite. A high aspect ratio kite will have a much greater span than its chord depth. High AR kites generate more lift and power than low AR kites and have a wider wind window and greater upwind performance. However, they have less stability than low AR kites: if they are depowered too much, too fast, they plummet from the sky. These characteristics make high AR kites unsuitable for use as towed kites coupled to, for example, a wakeboard rider. In sports such as wakeboarding, the need for rider control of the kite must be minimized so that the rider can focus on using and controlling the wakeboard. It has been found that an AR of from about 1:1 to about 2:1 facilitates auto-stability, overcoming the instability of conventional kites used in kiteboarding, for example. A low AR in a generally planform places most of the mass of the inventive airfoil far behind the tow point—this serves to reject yaw perturbations, for example, but also enables the inventive airfoil to reference the gravity gradient in the case of a roll disturbance.

Looking more particularly to the planing element configuration factor, to facilitate towing and take-off from a surface, the inventive airfoils are intended to be towed to a lift-off speed. That speed typically is from 8 to 10 mph. The kite planing elements may be anything that allows towing of the kite in a generally upright position during take-off, and which should not easily be damaged in the process. Typically, the planing elements are disposed at opposite sides of an airfoil's wingspan and are disposed so as to make contact with the take-off surface. In certain possible embodiments the planing elements also serve as the wing tips, 12A and 12B. For water towing, the planing elements may be buoyant elements that will run over the water surface, such as inflatable bladders. For hard or rough surfaces, the elements may be one or more sets of wheels, for example. For snow or ice, the elements may be skis or skids, which might also work on hard or rough ground surfaces too.

Looking more particularly at the drag element configuration factor, the inventive airfoil typically will have drag elements behind the tow point (where tow is generally centered). This configuration factor helps create a restoring force if the inventive airfoil is perturbed in yaw, for example. Looking at the kite of FIGS. 4A-G, note the right and left rear-stabilizing drag elements. The drag elements 15A-B shown in the Figures are upwardly projecting surfaces generally disposed on opposite sides of the top of the trailing edge TE of the airfoil. Although the drag elements are shown as separated surfaces, a drag element(s) may be a continuous surface extending along or one or more discrete surfaces in between the ends of the trailing edge or thereabout. The drag elements may also be other features that provide drag behind the tow point. For example, they could be panels of material connected to the top surface of the airfoil and fashioned to upwardly project therefrom. The panels could have a free top end portion that is connected to main body of the kite using struts or tensioned lines so that they project from the main body of the airfoil like flaps on an airplane.

In one possible embodiment, the drag elements 15A and 15B are inflatable projections on the kite. In this inventive example, the elements have a generally triangular shape. The elements add stability on the water during planing and control the angle of attack during takeoff.

Another configuration factor is the inclusion of an angle of attack through any cross section of the kite taken along the chord, which helps enable stability because the airfoil recovers more easily from perturbations left to right (roll). From the Figures, it can be seen that the leading edge of the airfoil has a greater radius relative to the trailing edge and therefore provides an angle of attack for any given longitudinal cross section. The angle of attack also continues for the tip portions 12A and 12B.

The tip portions 12A and 12B run generally between the leading and trailing edges, and are at the opposing ends of the wing span, may have a tubular construction with a greater radius for the tube at the front or leading edge with the radius tapering to the rear or trailing edge. This construction allows the rear portions of the tips to be relatively more flexible. During a roll, the rear section of the tip that is on the high side can therefore fall towards the center of the kite and catch more wind, which will act to on the tip section with a force to help correct the roll.

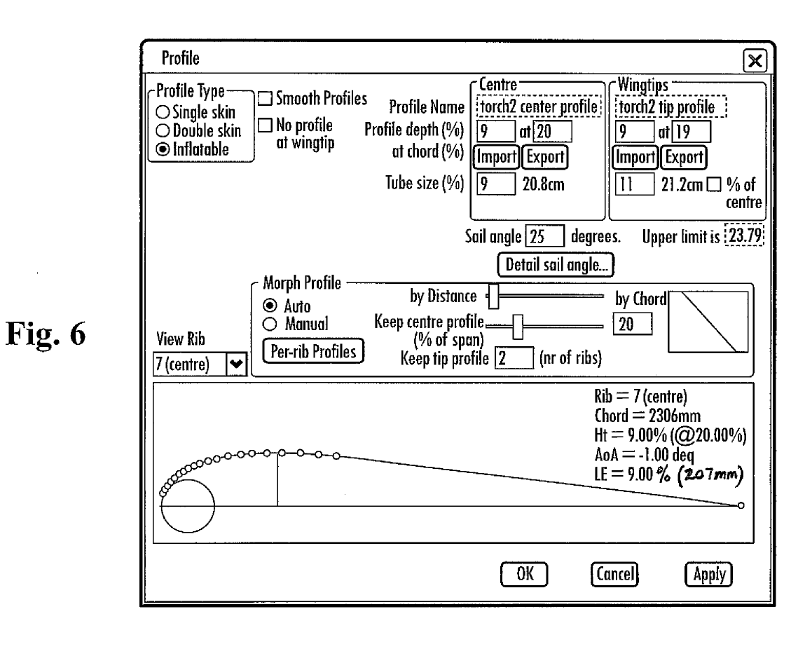

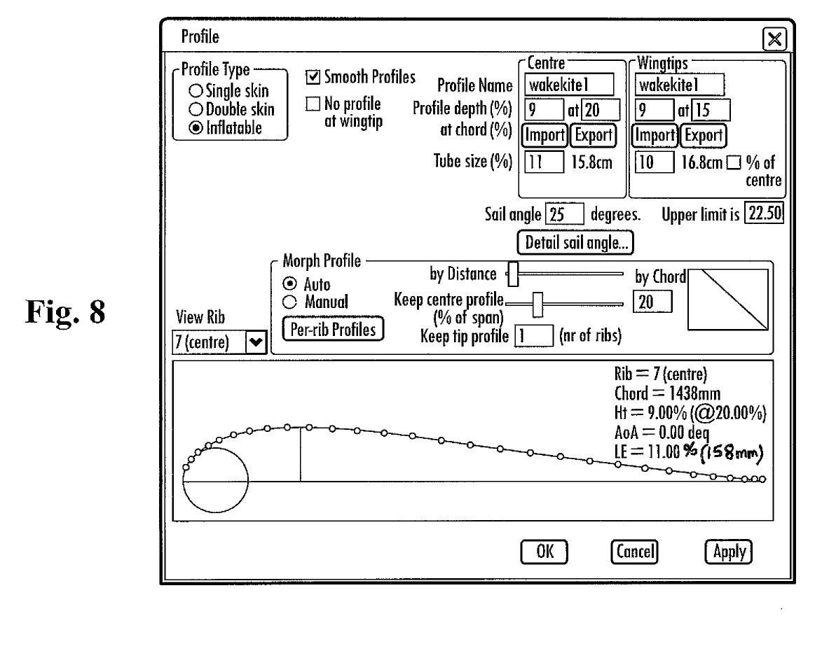

Another configuration factor is the use of a depth profile that is relatively thick, i.e., the thickness as a percentage of the chord is relatively large. A suitable configuration may be a profile with a maximum depth of about a 5% to about 15% of chord length, or more preferably, about 8% to about 15%, at about 15% to about 25% of the chord, measured from the front of the chord. FIGS. 6 and 8 give example profiles of different kites and show a maximum depth profile of 9% of chord length at 20% from the front of each kite's chord. The use of this configuration factor can contribute to helping a kite behave well at lower wind speeds. As can be seen, the maximum thickness of the profile is relatively far forward, i.e. it occurs at a low percentage of the chord from the front of the profile. This helps the canopy to retain its shape at a smaller angle of attack (pitch).

Publicly and commercially available computer programs that may be used in designing airfoils with desired characteristics are known and readily available to persons skilled in the art. One publicly distributed program is SurfPlan™ kite design software, which is available through http://www.surfplan.com.au/sp/downloads/index.htm, and user guides are available through www.kitesurfingschool.org. Another program is available under a GNU public use license from http://web.mit.edu/drela/Public/web/xfoil/.

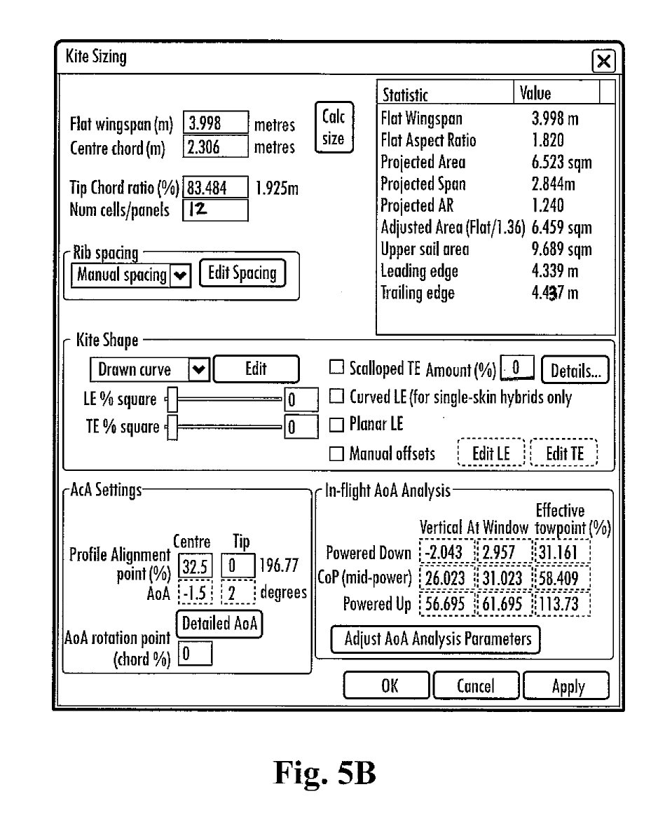

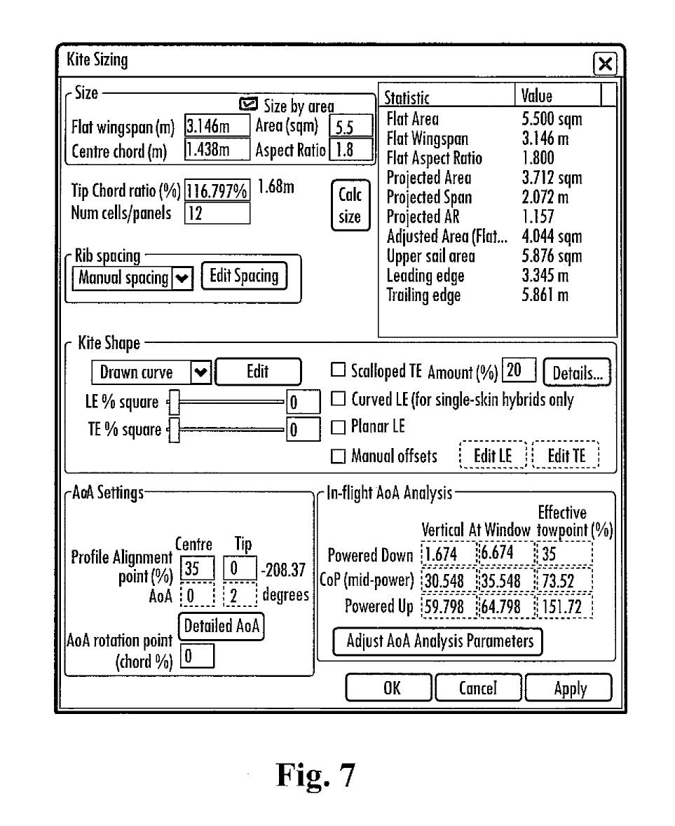

FIGS. 5-8 are screen shots of a user interface from a version of the SurfPlan™ kite design software, with parameters and data representing dimensions and profile data for embodiments of an airfoil according to the inventive subject matter. FIGS. 5 shows data for a boat-towed kite for wake boarding. The data includes AR data. FIG. 6 is data for the same kite, and it includes depth profile data. FIGS. 7 and 8 show screenshots corresponding respectively to FIGS. 5 and 6, but with data for a smaller kite that is intended to be more forgiving and manageable by new or lighter riders or in more rigorous wind conditions.

Line Systems

As depicted in the figures, the inventive airfoil 10 may be connected to a tensioned line such as a tow line 50 from a power boat. The rider grips a handle 40 that is a coupling between the tow line from the boat and the control lines 20, 30 for the kite, which extend to the kite's right and left sides. Alternatively, the lines may be coupled to the rider by other means, such as a vest or harness worn by the rider. The control lines couple the force of the airfoil to the handle and/or control the flight profile of the airfoil. The opposite ends of the control lines are coupled to the airfoil.

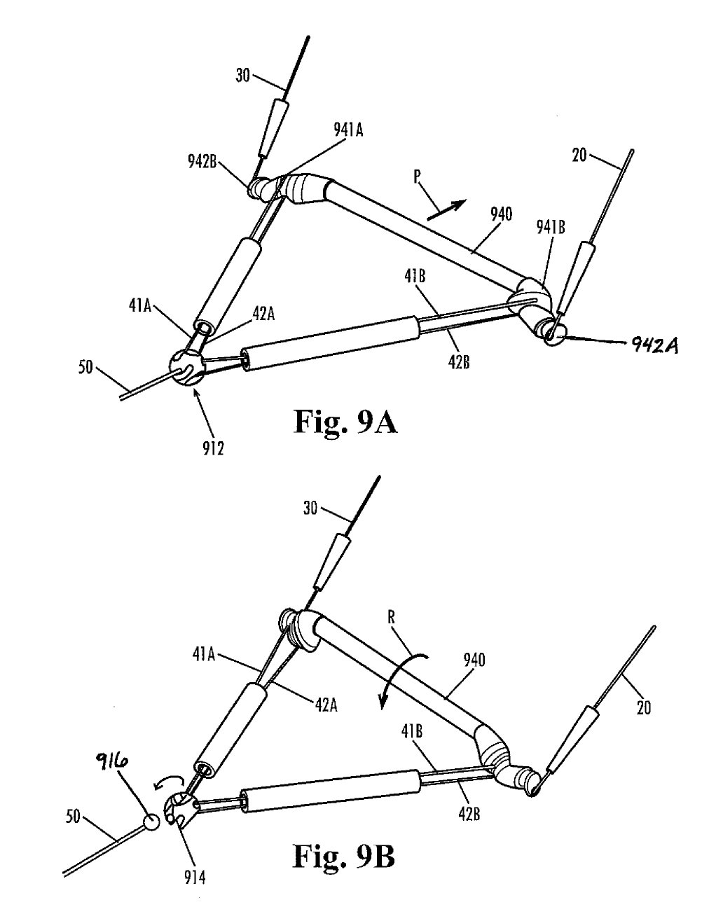

The tow line and handle system used with the inventive airfoil may be according to one or more of the inventive coupling systems described herein; however it may also be used with conventional tow line and handle systems. If the airfoil 10 is steerable, the rider steers the airfoil by articulating the handle in a side-to-side motion to change tension on right and left control lines 20, 30, which motion pulls on the control lines coupled to the airfoil. FIGS. 9A and 9B illustrate an example handle system for use with the airfoil. The handle is coupled to a tow line 40, either directly, or, as illustrated with lead lines off the handle, such as lines 41, 42. Airfoil control lines 20, 30 are also at one end directly or indirectly connected to the handle 40 and at the other end to a connection point directly or indirectly on the body of the airfoil. A typical indirect connection would be bridle lines on the kite. In the specific example shown, there are opposing airfoil lines at each end of the handle. In one possible embodiment, the lines emanate from the end faces of the handle so that the rotation of the handle by the rider does not wind the lines around the handle, as might occur if the lines emanated along the lengthwise surface of the handle.

The foregoing arrangement of lines provides a vertical force component behind the boat at the handle, enabling higher jumps, longer hang-time, and/or softer landings for the rider. The line system allows steering of the airfoil, which can increase the speed of the airfoil for larger jumps. Another possible line system for achieving this result is as described in U.S. Pat. No. 6,834,607, incorporated by reference above. In that system the airfoil control line(s) is coupled to the towline, so that the towline is provided with a vertical force component that is translated to the rider.

In the example shown, the opposite ends of the control lines 20, 30 are coupled to bridles 22, 32, or other couplings typically disposed at the front portions of the tips of the airfoil. In some embodiments, each side of the airfoil has a bridle line composed of two sections 22A, 22B and 32A and 32B—an elastic section and an inelastic section. An inelastic section 22A, 32A has an end that connects to the front portion of the airfoil. The elastic section 22B, 32B is rearward of the inelastic section and has an end that connects to a point rearward of the inelastic section's connection point. The elastic rear section of the bridle allows the tow point to move backward relative to the center of the lift pressure of the airfoil when the airfoil is at a lower angle of attack, which restores lift power to the airfoil, creates drag, and prevents over-flying.

In addition to a two line system, systems of four or more lines may be used to control specific aspects of an airfoil's flight profile. For example, a four line system may be used to control an airfoil's angle of attack. By controlling the airfoil's angle of attack, the rider may vary the amount of lift provided to the airfoil.

The lift system may have its own release mechanism. Certain inventive coupling release systems are described below.

### Line Coupling Systems

The inventive subject matter contemplates line coupling systems that releasable couple lines according to predetermined changes in tension (force). As used herein, “change in tension” generally means a change in the magnitude and/or direction of a tensioning force.

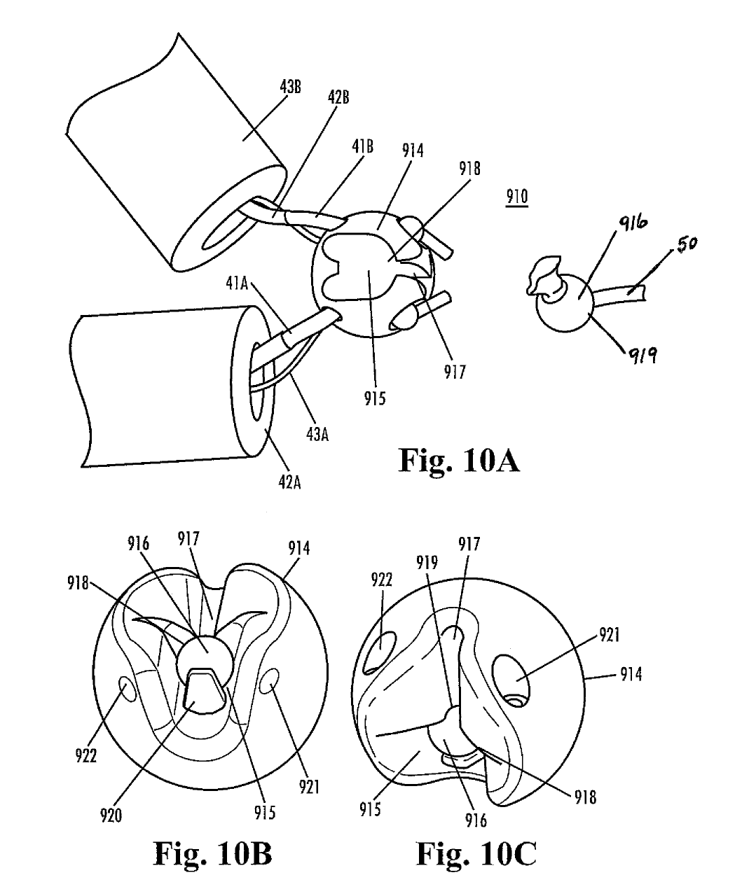

FIGS. 10A and 10B show a first embodiment of a release system 910. In a basic form, the release system includes a coupling apparatus 912 that releasably connects opposing tensioned lines that are coupled via the apparatus, such as lines 41A/B and 42A/B with towline 50. The coupling apparatus is adapted to release at least one of the tensioned lines when a neutral or stabilizing force is removed or overcome by the predetermined forces on one of the tensioned lines. One possible embodiment contemplates that a first force in a first plane is a stabilizing force that operates on the coupling apparatus to keep lines coupled and under tension, and a second force in a vertical or otherwise substantially transverse plane force acts to release the coupling apparatus when the stabilizing force is removed or overcome.

In one possible embodiment, a handle 40 that is connectable to a tensioned line, such as a tow line for a power boat or other towing vehicle, is connected to the coupling apparatus via lines 41A/B and 42A/B. Hereinafter the invention will be illustrated in respect to a tow line connected to a power boat, such as a ski boat. The handle is coupled to the tow line by a releasable coupling apparatus 912 that allows the handle, and anything connected to the handle, to safely separate from the tow line. In a neutral position, the handle will remain connected to the tow line through the coupling apparatus. However, if predetermined forces deviate the handle from its neutral position the coupling apparatus will release the handle from the coupling apparatus.

FIGS. 9A- 10B illustrate one possible embodiment of an inventive handle system for use with a wakeboard, for example, and the inventive airfoil lift system. The coupling system includes a handle 940 and an associated coupling apparatus 912 for receiving an end of two or more tensioned lines and an element for communicating a change in force to the coupling apparatus so as to cause the coupling apparatus to release at least one line.

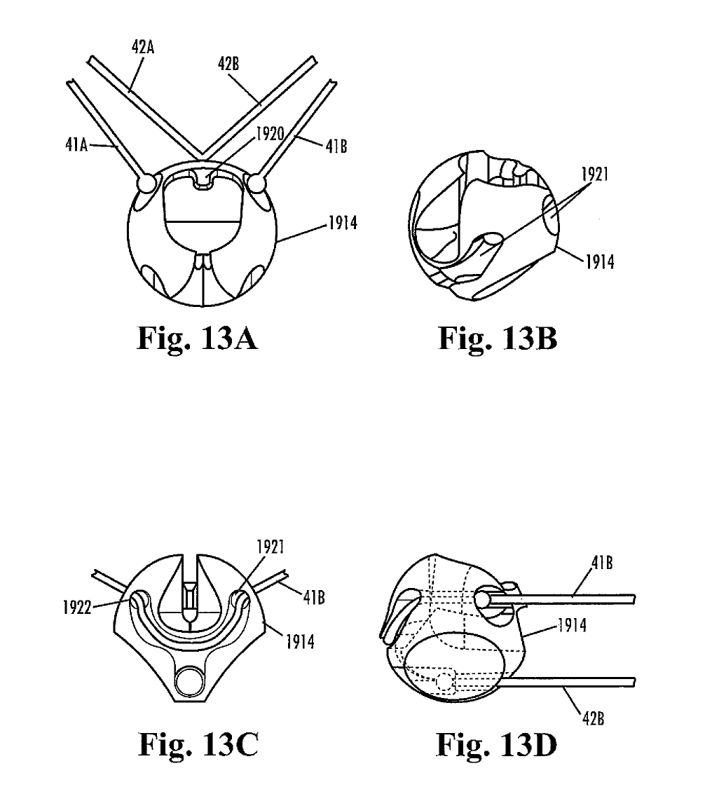

The coupling apparatus 912 may be in the nature of a receiver 914 and a releasable element 916 captured by the receiver, with each attached to one or more lines to be releasably coupled. For example, the receiver and release element may be in the form of a ball and socket. (Although shown as a ball and socket, the coupling, may be based on other shapes, as a person skilled in the art will understand from the teachings herein.) Optionally, the socket may be configured to provide a snap fit for the ball so that the ball is held in place at least under light tension thereby keeping the components together during storage, set-up, and slackness of line during jumping, etc. The socket 914 is configured to releasably receive a ball 916 at the rider end of a tow line 50. The socket includes a groove 917 for receiving a portion of the tow line 50. The groove is intended to orient in the direction of tension from the tow line when the ride is being pulled. Behind the groove 917 is a recessed area 915 that receives a ball 916 at the end of the tow line. The socket includes stop 918 that abuts a surface 919 of the ball facing the tow line 50 when it is placed in the groove. An opposite surface of the ball 916 abuts a catch 920. The catch may be flexible to accommodate placement of the ball. The combination of stop 918, catch 920 and the recessed surfaces of the socket between these parts and the side of the ball hold the ball in the socket when there is tension on towline 50 that is generally parallel to the direction of groove 917. Optionally, the socket may be configured to provide a snap or friction fit for the ball so that the ball is held in place at least under light tension thereby keeping the components together during storage, set-up, and slackness of line during jumping, etc. The socket has two opposing channels 921/922 for receiving and anchoring lines 41A/B and/or 42A/B. The channels are generally parallel to one another and to groove 917. Alternatively, the lines may be molded into a moldable material used to make the coupling apparatus components. Fasteners may also be used alone or in combination with channels or molding. The orientation of these parts corresponds to the general direction of tension on the lines 41A/B and 50 when a rider is coupled to handle 40 or 940 and is being towed. FIGS. 13A-D show another possible embodiment of an inventive line coupling system for use in a line system for a towed lift device, which is a variation of the coupling system of FIGS. 10-C. These figures help illustrate ways of routing or connecting lines to or through a socket. In this set of figures, reference numbers 1914 and 1920, 1921, and 1922 correspond generally to reference numbers 914 and 920, 921, and 922 in FIGS. 10A-C.

Notably, the recessed area leaves one side of the ball uncovered. If the tension on the socket is such that the ball rotates clockwise along the direction of the groove, the tension from the tow line will no longer be oriented parallel to the groove and the, the ball will be released. This may be desirable when a rider lets go of a handle so that the kite is released and can be retrieved, as described in more detail below.

Hereinafter, inventive handle 940, which may be referred to as a “release handle”, will illustrate an element capable of transmitting a coupling force or decoupling force to cause a kite to be decoupled when a rider releases the handle. The release handle has two functions (1) to react when a rider released the handle, and (2) once the rider releases the handle, to separate the coupling between the airfoil and the tow line via the handle.

The handle shown is in the nature of an elongate bar. Normally, when a rider holds the handle there is a stabilizing force P from the pull of the rider on one end and the tow vehicle on the other end. The tension of the opposing lines 41A/B and towline 50 in this condition is parallel and oriented along the direction of groove 917 in the coupling apparatus 912. The release handle reacts when a rider drops the handle because of the offsetting of the attachment points 94 1A/B for lines 41A/B and 942A/B for control lines 20, 30 and the “bar” lines 41A/B (FIG. 9A). These offsets may be based on varying radii of the attachment points from a general central longitudinal axis of the handle. This may be achieved, for example, by bends or curves in the handle, as shown or by varying the diameter of tube or shaft serving as the handle.

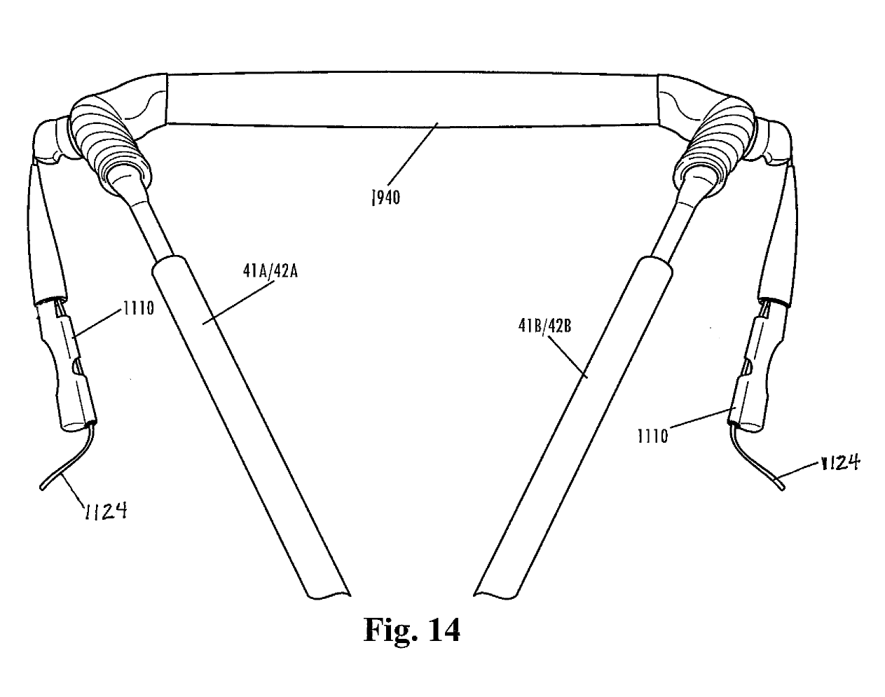

FIG. 14 shows a design variation of a handle system that generally operates using the same principles as that of the system in FIG. 9A. The system includes a handle 1940, which generally corresponds to handle 940 in FIG. 9A. A release system 1110 (discussed below) is associated with the bar ends of the handle. As indicated in the illustration, lines to the handle are covered in flexible tubing.

If the rider drops the handle, the forces of the control lines 20, 30, which typically are still under tension of a flying kite, and lines 41A/B rotate the bar 940, as indicated by arrow R. In so doing, “trigger” lines 42A/B are shortened relative to the bar lines 41A/B, and the coupling apparatus s rotated. As the release ball rotates, the tow ball is released from the release ball and the coupling between the airfoil and the tow line via handle 940 is undone (FIG. 10B).

In addition to the tow line coupling apparatus detailed in FIGS. 9A-10B, the line system may also incorporate one or more additional couplings for coupling to a tensioned line.

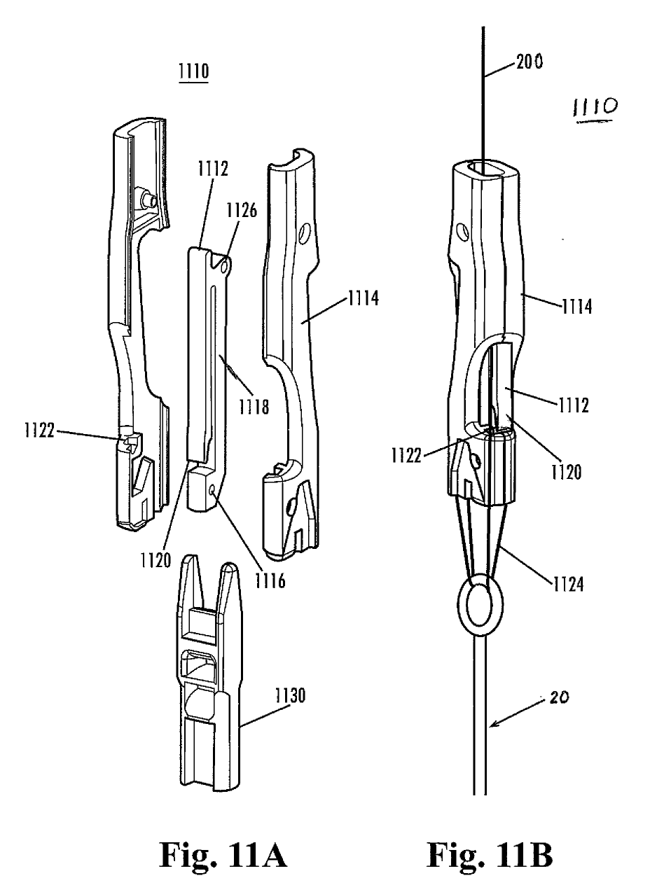

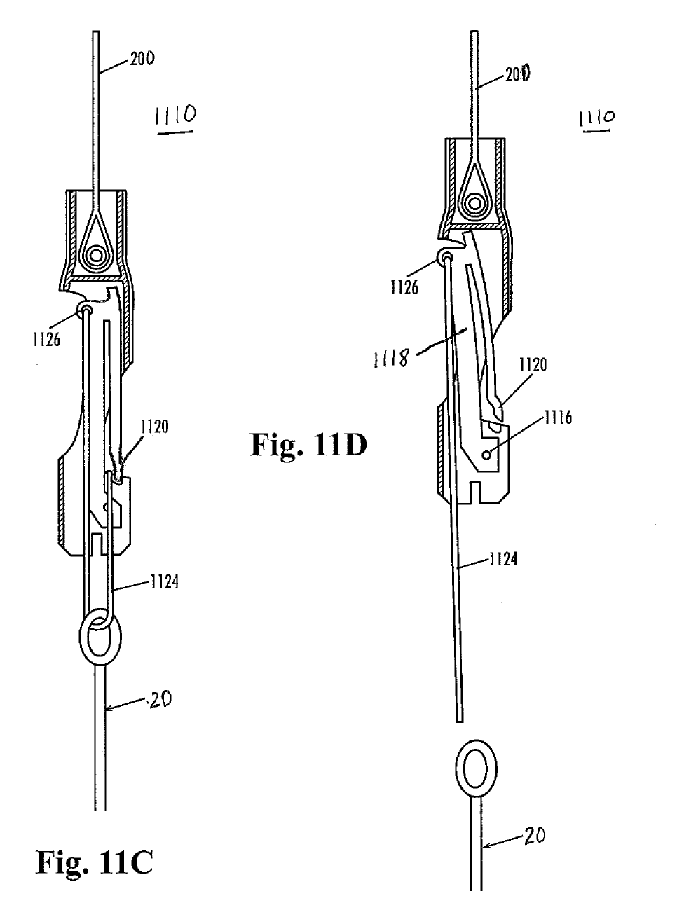

FIGS. 11A to 11D illustrate another possible embodiment of a release system 1110 that provides release of tensioned lines upon a predetermined maximum tension. Accordingly, the apparatus may be used to help provide a safer line system and should help reduce the risk of rider and line entanglements or damaged equipment.

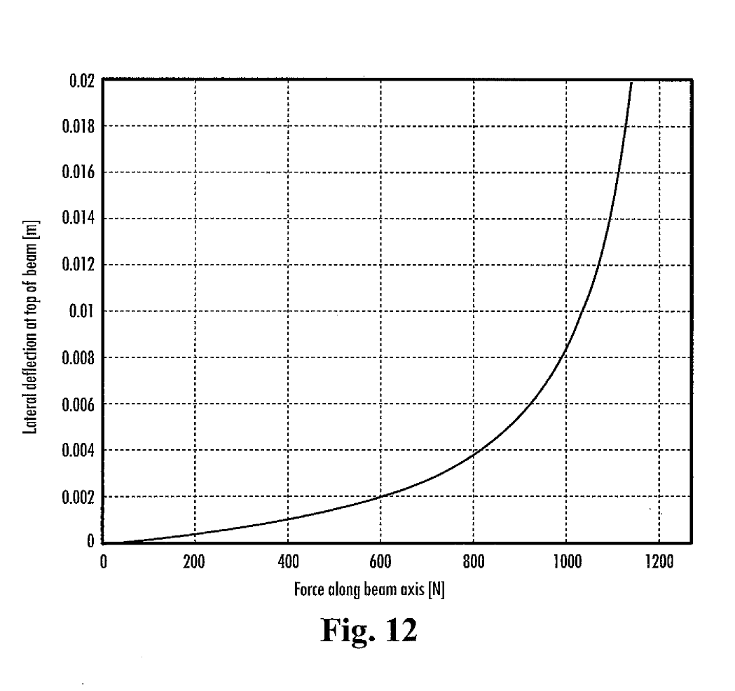

The apparatus shown in the FIGS. 11A-D is a reloadable apparatus that allows recoupling after a decoupling event. In contrast to prior art devices that release under predetermined tension, the inventive subject matter provides both an improved ease of reloading and a non-linear response to force. A non-linear response curve allows for repeatable decoupling whenever the apparatus is subject to a predetermined line tension and is particularly advantageous at being insensitive to changes in friction, material properties, and geometry. In other words, in a graph (FIG. 12) of deformation (y-axis) deformation to force, the curve is initially shallow and there is little deformation with increasing force, and then at a predetermined force there is a steeper rise in deformation, allowing for the mechanism to release a line. For example, because the beam has a moveable end portion, it may suffer wear and tear during use or be subject to manufacturing variances that might otherwise affect its ability to repeatedly release under a given force. The non-linear nature of the beam's response to force generally allows for substantial variation from a specified geometry to have relatively small influences on the force required to activate the release catch.

The inventive subject matter contemplates a coupling apparatus for releasably coupling a tensioned line, the apparatus comprising: a beam having a longitudinal axis and an eccentricity disposed therefrom at a deflectable end; a second end anchored to a housing portion, a release catch coupled (directly or indirectly) to the deflectable end of the beam and in combination with a housing portion defining an area for releasably capturing a closed end line or loop, wherein the eccentricity is adapted to be an anchor for a tensioned line or structure such that a predetermined amount of tension causes deflection of the beam and couplingly opens the release catch to release a line in the area defined by the release catch and housing portion. FIG. 11A shows an exploded view of one possible embodiment of such a coupling apparatus that features a deflectable beam 1112 for providing a non-linear response to force. In this example, the deflectable beam is disposed in a housing 1114. A first end 1116 of the beam is anchored to the housing creating a cantilevered support for deflection of the free portion 1118 of the beam. The housing is adapted to allow the beam to deflect enough to open a release catch 1120. A stop 1122 may be provided on the housing to limit the deflection so that the beam does not overly deflect to a possible material failure. The anchored end of the beam may be anchored by an interference fit with the housing and/or with fasteners, for example. FIG. 11B shows an assembled view of the housing and beam of FIG. 11A. The housing is coupled to a first line, such a kite control line 20, or a rope or cable 200, shown extending from the top of the housing. A releasable second line 1124 is shown coupled to the housing assembly and extends away from the bottom of the assembly.

The second line 1124 is connected to an eccentricity 1126 offset from the longitudinal axis of the beam. The portion of the second line that extends down from the deflectable end of the beam extends through a channel in the housing. The channel is disposed along a wall of the housing at a portion opposite the portion of the housing where the first line is anchored. The second line runs through the channel, doubles back on the housing, and is captured between a notch in the housing and the release catch 1120 on the beam. This end of the line is a loop portion of the line, if the line itself is not a closed loop line. The area defined by the housing and the release catch will keep the line connected so long as a predetermined defamation force is not acting on the eccentricity.

The release catch 1120 is coupled to the deflectable end of the beam so that its movement is tied to the movement of the deflectable end. In the example shown, the release catch is disposed on the end of an arm extending downwardly from and generally parallel to the deflectable end of the beam. An initial applied force by the second line acts at both the eccentricity and at the catch area. Accordingly, the force at the eccentricity acts primarily as a compressive force on the beam. Deflection of the beam is caused by the tension in the line loading the beam in compression eccentric to the beam's longitudinal axis. This causes buckling of the beam which creates the non-linear relationship between the tension and deflection of the beam. Materials that would provide for this relationship generally include materials that are rigid but which are also resilient under a desired range of force and/or deflection. Such materials may, for example, include metals, plastics, and composites.

The embodiment shown in the figures is suitable for use as a coupling apparatus for an airfoil tow system. It may be made from a Delrin plastic. The beam and housing may be injection molded parts. A suitable length and thickness for the beam shown in the figures is ¼ inch thickness and about 2½ inches long and the width is about ¼ inch. The beam includes a compression loading eccentricity of about ⅛ inch from the longitudinal axis of the beam. The stiffness of the beam may be varied so that it may be adapted to release on a desired force. Variations in stiffness may be achieved by changing dimensions and/or material properties of the beam.

Although the beam is shown as carrying an arm on which the release is disposed, the beam and release need not be directly connected. For example, the deflection of the free end of the beam could be coupled to an intermediate structure that separates the release catch from the housing, allowing the second line to be released. An example of an intermediate structure is a rigid or flexible linkage.

FIGS. 11B, 11C, and 11D illustrate one possible way that the second line may be coupled to another structure. The other structure may be, for example, a tow line 30 or an airfoil line, if the second line itself is not a tow line or an airfoil line. A loop is disposed on the end of such line. The second line's free end is looped through and into the catch release area of the coupling apparatus (FIGS. 11B and 11C). When a predetermined force is applied, the second line will slip through the loop on the other line, releasing it (FIG. 11D).

FIG. 11A shows an optional line stiffening element 1130 that mates closely with the housing so that a kink point is not formed at the area of line near the coupling apparatus. The stiffening element may be used instead of the loop at the end of the tow line or airfoil line, as described above. The housing may have complementary engageable male and female portions that releasably interlock at a force below that of the predetermined release force for the release catch. The stiffening element also has a first aperture for receiving the second line and a second aperture for receiving the tow line or airfoil line.

Although the coupling apparatus has been described in terms of coupling a two-line system, the first line need not be present, and instead the coupling apparatus may be attached to or integrated into a fixed structure which is placed in tension with the second line. Also, while the housing for the coupling apparatus has been shown as a separate element from the beam, both structures may be made unitary, by molding techniques, for example. Notably, such a structure need not have the full length housing of FIGS. 11A through 11D. Instead the housing portion is at least present to provide an anchor area and a line channel to orient the line generally parallel to the axis of the beam. The housing portion may also be at least present to define, in combination with a release catch, the area for capturing the second line.

### Miscellaneous

Flexible casings, such as tubes, indicated in FIGS. 10A and 14, may be used over any of the line systems discussed herein to protect the lines, to stiffen against entanglement, or reduce drag in water.

The kite may be assembled or fabricated from one or more panels of material, as disclosed in U.S. Pat. No. 6,834,607, which has been incorporated by reference. The kite may have structural ribs or struts, such as tubes, rods, inflatable bladders, or other elongate members, which are generally indicated at 12A, 12B and 17A, 17B in the FIGS. 4E and 4F, for example. All or some of the leading edge and/or trailing edge may also include such structural supports. Further, the structural supports for one area may merge with those for another area. For example, 4F shows a continuous bladder, across the leading edge LE through the tips 12A and 12B.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

1. A release system, comprising:
a coupling apparatus comprising a receiver and release element that is received by the receiver, each of which is connectable to an opposing line and holding the lines in coupled tension under a stabilizing force acting in a first plane; and wherein the coupling apparatus is adapted to release at least one of the tensioned lines when the stabilizing force is removed or overcome by a predetermined force in a transverse plane to the first plane.

2. The release system of claim 1 wherein the receiver includes a recessed area for receiving the receiving element, the recessed area including a surface against which the receiving element abuts under a tension of the opposing lines, and recessed area has an open side through which the receiving element disengages under the transverse force.

3. The system of claim 2 wherein the opposing lines and the abutment surface all lie in substantially the first plane and the open side is facing transverse from the first plane.

4. The system of claim 1 wherein the system further comprises a handle for use by a rider being towed by a vehicle, the handle having at least one of the opposing lines coupled to the coupling apparatus and the release element is coupled to the other opposing line.

5. The system of claim 4 wherein the handle further includes at least a second line that is connected to the handle in a manner offset from the first line coupled to the handle such that rotation of the handle differentially changes the lengths of the lines, causing the receiver to rotate, releasing the release element.

6. The system of claim 5 wherein the handle further includes a line for coupling an airfoil that is offset from another one of the lines coupling the handle to the coupling apparatus.

7. The system of claim 6 wherein when the stabilizing force is removed, the handle, under sufficient tension from a kite line, will rotate and cause the receiver to rotate and release the release element.

8. The system of claim 6 further comprising a tow line coupled to the release element.

9. The system of claim 4 wherein the line coupled to the release element comprises a tow line for a rider to be towed by a boat, the handle further including lines or coupling for coupling to an airfoil.

10. A handle system comprising an elongate bar for a rider to grip while being towed; the handle being configured to couple with a tow line, and the handle additionally being configured to couple with one or more airfoil lines, the coupling point of the one or more airfoil lines being a point for vertical lift when a coupled airfoil is in flight.

11. The handle system of claim 10 further comprising a coupling apparatus for coupling the handle to a tow line, the coupling apparatus being releasable from the tow line upon a predetermined change in tension to the apparatus.

12. A handle system for coupling lines in an airfoil towing system comprising a coupling apparatus for coupling a pair of lines, the coupling apparatus being releasable from a line upon a predetermined change in tension to the apparatus.

13. The handle system of claim 12 further comprising a handle for a towed rider coupled to the coupling apparatus, and wherein the coupling apparatus is disposed between the handle and lines for or coupling to an airfoil.

14. The handle system of claim 12 further comprising a handle for a towed rider coupled to the coupling apparatus, and a tow line for a rider, and wherein a first coupling apparatus is disposed between the handle and a towline, and a second coupling apparatus is disposed between a handle and a line for an airfoil.

15. The handle system of claim 14 wherein the handle comprises an elongate element that includes at least two connection points that are offset by virtue off having different radii from a central axis of the bar.

16. The system of claim 12 further comprising an airfoil having an aspect ratio of from about 1:1 to about 2:1; and planing elements on opposite sides of the airfoil span to facilitate planing of the airfoil on a surface, so as to maintain the airfoil in an upright position in take-off.

17. A coupling apparatus for releasably coupling a tensioned line, the apparatus comprising:
a beam having a longitudinal axis and an eccentricity disposed therefrom at a deflectable end;
a second end anchored to a housing portion,
a release catch coupled to the deflectable end of the beam and in combination with a housing portion defining an area for releasably capturing a closed end line or loop, wherein the eccentricity is adapted to be an anchor for a tensioned line or structure such that a predetermined amount of tension causes deflection of the beam and couplingly opens the release catch to release a line in the area defined by the release catch and housing portion.

18. The coupling apparatus of claim 17 wherein the relationship between the deformation of the deflectable portion of the beam and the force on the beam is non-linear.

19. A method of making a coupling apparatus comprising:
providing a receiver and a release element that is received by the receiver, fashioning the receiver so that it is connectable to one of an opposing line and fashioning the release element so that it is connectable to a second opposing line, the receiver and release element being able to hold the lines in coupled tension under a stabilizing force acting in a first plane; and wherein the coupling apparatus is adapted to release at least one of the tensioned lines when the stabilizing force is removed or overcome by a predetermined force in a transverse plane to the first plane.

20. A method of using a line system in a lift system, comprising:
providing a handle that is configured to couple to a towline and an airfoil, the line system including a first releasable coupling disposed between the handle and towline or the handle and airfoil, the release system being reliable on a predetermined change in tension in a line coupled to the release system;
providing an airfoil couplable to the handle
coupling the line system to an airfoil and vehicle; and
towing a rider holding the handle.
